(19) United States
(12) Patent Application Publication
(10) Pub. No.: US 2023/0234312 A1
(43) Pub. Date: Jul. 27, 2023

(54) Shoe Mold Structure and Method of Using the Same

(71) Applicant: Sunko Ink Co., Ltd., Taichung City (TW)

(72) Inventor: Ting-Ti Huang, Taichung City (TW)

(21) Appl. No.: 17/648,815

(22) Filed: Jan. 25, 2022

(51) Int. Cl. B29D 35/00; B29C 44/12; B29C 44/34; B29C 44/58; B29C 44/04

(52) U.S. Cl. CPC B29D 35/0063; B29C 44/12; B29C 44/3415; B29C 44/583; B29C 44/0407; B29L 2031/50

(57) ABSTRACT

A shoe mold structure has a mold with a first end and a second end opposite to each other, an extending direction between the first and second ends is a longitudinal direction, the mold further has a mold cavity recessed inward from the second end and is composed of a bottom wall and side walls, each of the side walls defines a first side section, a second side section and a third side section connected in sequence along the longitudinal direction, the second side section is located between the first and third side sections, the first side section is closer to the first end than the third side section, the third side section is closer to the second end than the first side section, the second side section has an accommodating groove; and a heating unit disposed in the accommodating groove, and the heating unit provides heat energy.

### BACKGROUND OF THE INVENTION

### Field of Invention

The invention relates to a mold, more particularly to a shoe mold structure for footwear components.

The invention further relates to a method of using the above-mentioned shoe mold structure.

### Description of Related Art

General shoe components, such as shoe midsole or shoe outsole, can be bonded together with adhesives. The conventional method is to raise the temperature of the components by means of an oven, etc., so that the adhesive can obtain a sufficient temperature. However, the method of using conventional heat sources has drawbacks such as low efficiency.

In view of the above drawback, microwave heating has emerged in the industry, and the shoe parts to be processed are made of foamed materials, such as EVA (ethylene-vinyl acetate copolymer), etc. The conventional microwave heating method makes microwaves penetrate the mold and directly heat the shoe parts, although microwaves penetrating the mold to directly heat the shoe parts is helpful for combination of the shoe components, it is still prone to the problem of uneven heating. In addition, microwaves will cause qualitative change and deterioration to the shoe vamp or the shoe outsole, which will affect the quality of the shoe body. Therefore, a shoe mold structure and a method of using the shoe mold structure capable of overcoming the above problems are required.

### SUMMARY OF THE INVENTION

The invention provides a shoe mold structure with a main object of effectively combining a shoe outsole with a shoe vamp, and avoiding qualitative change and deterioration of the shoe outsole and the shoe vamp.

The invention further provides a method of using the above-mentioned shoe mold structure.

In order to achieve the foregoing object, the shoe mold structure of the invention comprises:
a mold with a first end and a second end opposite to each other, an extending direction between the first end and the second end is a longitudinal direction, the mold further has a mold cavity, the mold cavity is recessed inward from the second end, the mold is composed of a bottom wall and a plurality of side walls, each of the side walls defines a first side section, a second side section and a third side section connected with one another in sequence along the longitudinal direction, the second side section is located between the first side section and the third side section, the first side section is closer to the first end than the third side section, the third side section is closer to the second end than the first side section, the second side section has an accommodating groove; and
a heating unit disposed in the accommodating groove, and the heating unit provides heat energy.

The invention further provides a method of using the shoe mold structure comprising:
a step of inserting a shoe vamp, providing the mold and a shoe vamp, placing the shoe vamp upside down into the mold cavity, the shoe vamp having a shoe sole;
a step of inserting foams, placing a plurality of foams into the mold cavity and placing the foams on the shoe sole;
a step of inserting a shoe outsole, placing a shoe outsole into the mold cavity, placing the shoe outsole on the foams to position the foams between the shoe vamp and the shoe outsole;
a mold closing step, closing the mold cavity of the mold; and
a heating step, separately heating the foams through the heating unit to form a shoe midsole, and connecting the shoe vamp with the shoe outsole through the shoe midsole.

It can be known from the foregoing that, the shoe mold structure of the invention mainly defines each of the side walls as the first side section, the second side section and the third side section, so that a position of the second side section corresponds to the foams, the accommodating groove is opened in the second side section, the heating unit is disposed in the accommodating groove, and the heating unit heats the foams separately to avoid qualitative change and deterioration of the shoe outsole and the shoe vamp.

### BRIEF DESCRIPTION OF THE DRAWINGS

FIG. 1 is a cross-sectional view of a shoe mold structure.

FIG. 2 is a schematic diagram of a shoe vamp.

FIG. 3 is a schematic diagram of the shoe vamp disposed in the shoe mold structure.

FIG. 4 is a schematic diagram of foams covering the shoe vamp.

FIG. 5 is a schematic diagram of a shoe outsole covering the foams.

FIG. 6 is a schematic diagram of forming a shoe midsole after heating the foams.

FIG. 7 is a schematic diagram of a shoe molded product.

FIG. 8 is a flow chart of a method of using the shoe mold structure.

### DETAILED DESCRIPTION OF THE INVENTION

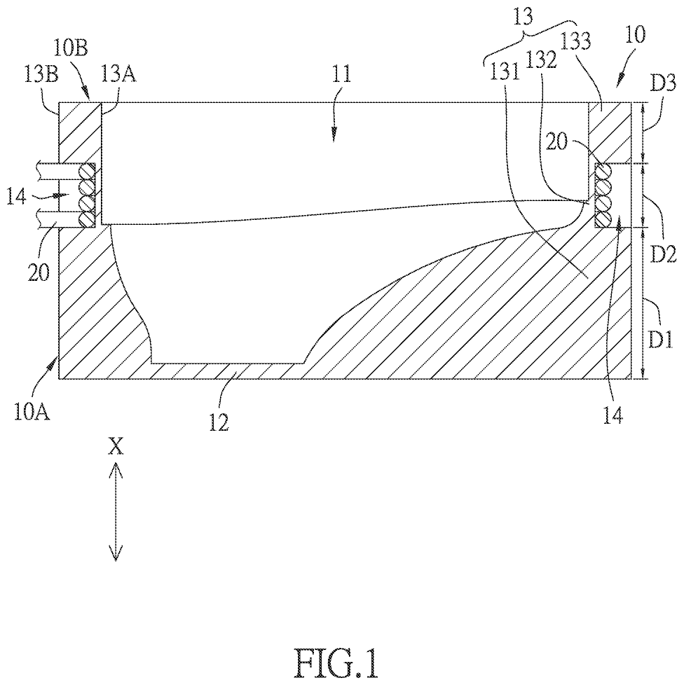

Please refer to FIG. 1, the invention provides a shoe mold structure mainly comprising a mold 10 and a heating unit 20.

The mold 10 is made of a metal material, the mold 10 has a first end 10A and a second end 10B opposite to each other, an extending direction between the first end 10A and the second end 10B is a longitudinal direction X. The mold 10 further has a mold cavity 11, the mold cavity 11 is provided for accommodating a shoe vamp A1, a plurality of foams A2, and a shoe outsole A3. The foams A2 can be ETPU foam material or ETPU foam material mixed with TPU material or ETPE material mixed with TPE material, and the foams A2 are in granular form. The shoe outsole A3 can be made of rubber material or ETPU foam material or ETPU foam material mixed with TPU material or ETPE material mixed with TPE material. The mold cavity 11 is recessed inward from the second end 10B. The mold 10 is composed of a bottom wall 12 and a plurality of side walls 13, each of the side walls 13 further defines a first side section 131, a second side section 132 and a third side section 133 connected with one another in sequence along the longitudinal direction X, the second side section 132 is located between the first side section 131 and the third side section 133, the first side section 131 is closer to the first end 10A than the third side section 133, the third side section 133 is closer to the second end 10B than the first side section 131, and the second side section 132 has an accommodating groove 14.

Lengths of the first side section 131, the second side section 132 and the third side section 133 along the longitudinal direction X are respectively a first length D1, a second length D2 and a third length D3. A ratio of the first length D1, the second length D2 and the third length D3 is between 2:1:1 and 3:1:1.

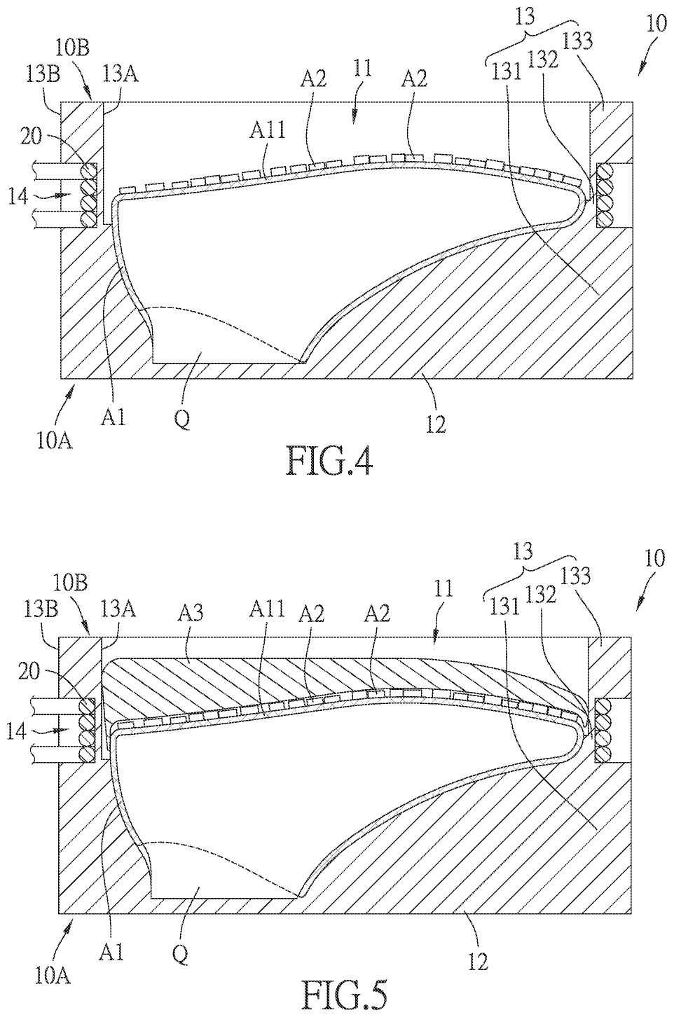

In this embodiment, when the shoe vamp A1, the foams A2, and the shoe outsole A3 are placed in the mold cavity 11, a position of the first side section 131 corresponds to the shoe vamp A1, a position of the second side section 132 corresponds to the foams A2, and a position of the third side section 133 corresponds to the shoe outsole A3, but are not limited thereto, in other embodiments, a position of the second side section 132 corresponds to the foams A2 and a part of the shoe vamp Al and a part of the shoe outsole A3 as shown in FIGS. 4 and 5.

In this embodiment, each of the side walls 13 has an inner side surface 13A and an outer side surface 13B facing oppositely, the inner side surface 13A faces the mold cavity 11, the accommodating groove 14 is recessed from the outer side surface 13B, but is not limited thereto, in other embodiments, the accommodating groove 14 is recessed from the inner side surface 13A.

The heating unit 20 is disposed in the accommodating groove 14, the heating unit 20 provides heat energy. The heating unit 20 can be a heating coil, and the heating coil is capable of providing heat energy after being energized.

It can be known from the foregoing that, the shoe mold structure of the invention mainly defines each of the side walls 13 as the first side section 131, the second side section 132 and the third side section 133, so that a position of the second side section 132 corresponds to the foams A2, the accommodating groove 14 is opened in the second side section 132, the heating unit 20 is disposed in the accommodating groove 14, and the heating unit 20 heats the foams A2 separately to avoid qualitative change and deterioration of the shoe outsole A3 and the shoe vamp A1.

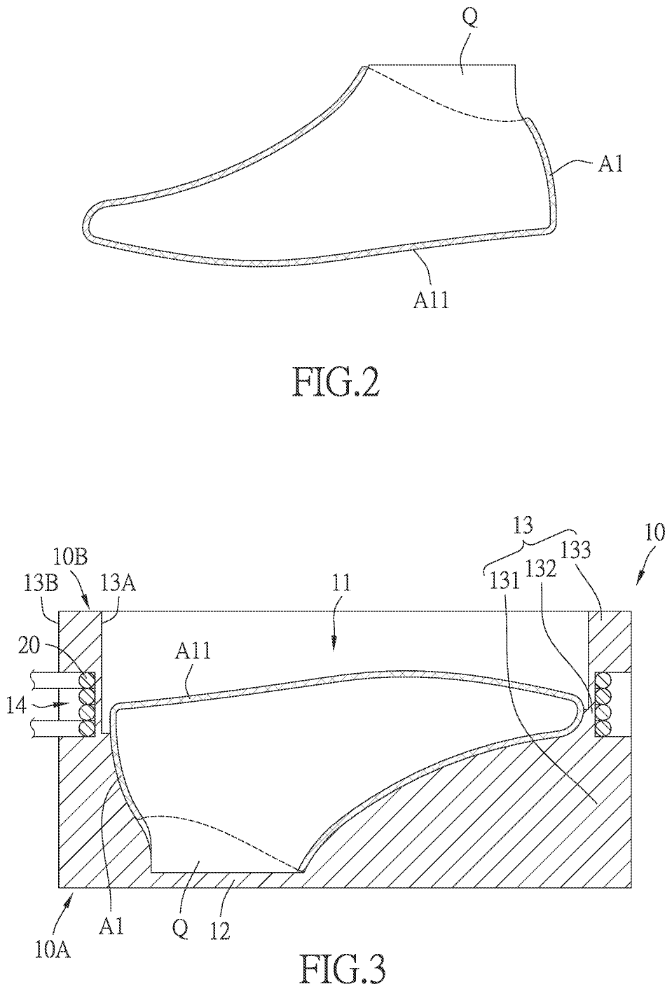

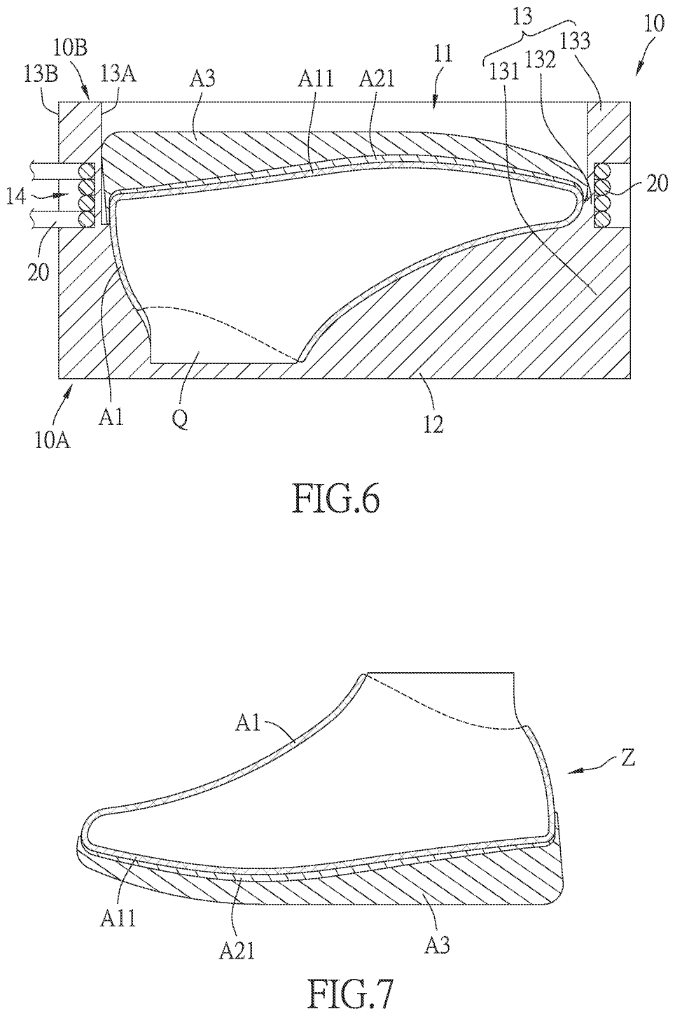

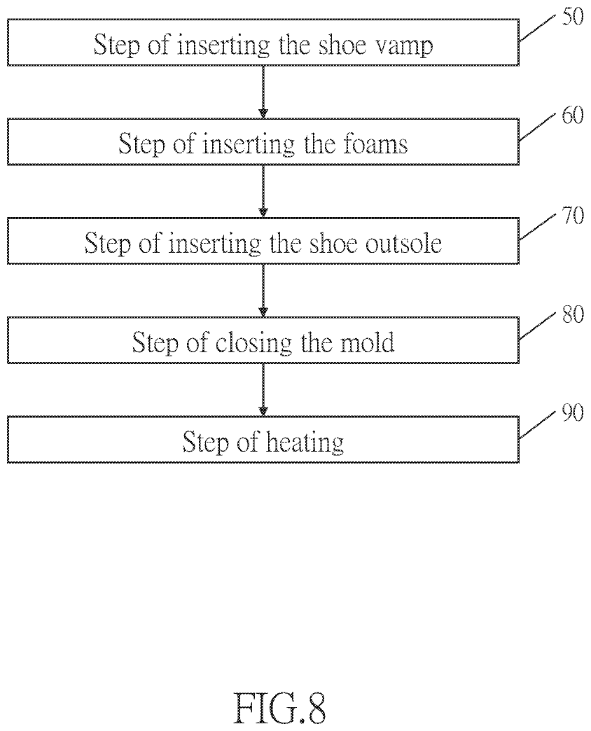

Please refer to FIGS. 3 to 6 and 8, the invention further provides a method of using the shoe mold structure comprising:
a step 50 of inserting the shoe vamp, please refer to FIG. 3, providing the mold 10 and the shoe vamp A1, the shoe vamp A1 being a three-dimensional fabric, placing the shoe vamp A1 upside down into the mold cavity 11, wherein inside the shoe vamp A1 has a shoe last Q, the shoe vamp A1 has a shoe sole A11;
a step 60 of inserting the foams, please refer to FIG. 4, placing the foams A2 into the mold cavity 11 and placing the foams A2 on the shoe sole A11;
a step 70 of inserting the shoe outsole, please refer to FIG. 5, placing the shoe outsole A3 into the mold cavity 11, placing the shoe outsole A3 on the foams A2 to position the foams A2 between the shoe vamp A1 and the shoe outsole A3;
a mold closing step 80, closing the mold cavity 11 of the mold 10; and
a heating step 90, please refer to FIGS. 5 and 6, separately heating the foams A2 through the heating unit 20 to foam the foams A2 in order to form a shoe midsole A21 with light weight and good elasticity, and connecting the shoe vamp Al with the shoe outsole A3 through the shoe midsole A21 to form a shoe molded product Z.

Although the specific embodiments of the invention are disclosed in the above implementation modes, they are not intended to limit the invention. The specification relating to the above embodiments should be construed as exemplary rather than as limitative of the invention, with many variations and modifications being readily attainable by a person having ordinary skill in the art to which the invention pertains without departing from the principles and spirit thereof as defined by the appended claims and their legal equivalents.

1. A shoe mold structure comprising:
a mold with a first end and a second end opposite to each other, an extending direction between the first end and the second end being a longitudinal direction, the mold further having a mold cavity, the mold cavity being recessed inward from the second end, the mold cavity being composed of a bottom wall and a plurality of side walls, each of the side walls defining a first side section, a second side section and a third side section connected with one another in sequence along the longitudinal direction, the second side section being located between the first side section and the third side section, the first side section being closer to the first end than the third side section, the third side section being closer to the second end than the first side section, the second side section having an accommodating groove; and
a heating unit disposed in the accommodating groove, and the heating unit providing heat energy.

2. The shoe mold structure as claimed in claim 1, wherein the mold cavity is provided for accommodating a shoe vamp, a plurality of foams, and a shoe outsole, a position of the first side section corresponds to the shoe vamp, a position of the second side section corresponds to the foams, and a position of the third side section corresponds to the shoe outsole.

3. The shoe mold structure as claimed in claim 1, wherein the mold cavity is provided for accommodating a shoe vamp, a plurality of foams, and a shoe outsole, a position of the first side section corresponds to the shoe vamp, a position of the second side section corresponds to the foams and a part of the shoe vamp and a part of the shoe outsole, and a position of the third side section corresponds to the shoe outsole.

4. The shoe mold structure as claimed in claim 1, wherein each of the side walls has an inner side surface and an outer side surface facing oppositely, and the accommodating groove is recessed from the outer side surface.

5. The shoe mold structure as claimed in claim 1, wherein each of the side walls has an inner side surface and an outer side surface facing oppositely, and the accommodating groove is recessed from the inner side surface.

6. The shoe mold structure as claimed in claim 1, wherein the mold is made of a metal material.

7. The shoe mold structure as claimed in claim 1, wherein lengths of the first side section, the second side section and the third side section along the longitudinal direction X are respectively a first length, a second length and a third length, and a ratio of the first length, the second length and the third length is between 2:1:1 and 3:1:1.

8. The shoe mold structure as claimed in claim 1, wherein the heating unit is a heating coil.

9. A method of using the shoe mold structure as claimed in claim 1 comprising:
a step of inserting a shoe vamp, providing the mold and a shoe vamp, placing the shoe vamp upside down into the mold cavity, the shoe vamp having a shoe sole;
a step of inserting foams, placing a plurality of foams into the mold cavity and placing the foams on the shoe sole;
a step of inserting a shoe outsole, placing a shoe outsole into the mold cavity, placing the shoe outsole on the foams to position the foams between the shoe vamp and the shoe outsole;
a mold closing step, closing the mold cavity of the mold; and
a heating step, separately heating the foams through the heating unit to form a shoe midsole, and connecting the shoe vamp with the shoe outsole through the shoe midsole.
